(19) United States
(12) Patent Application Publication
(10) Pub. No.: US 2024/0186540 A1
(43) Pub. Date: Jun. 6, 2024

(54) BLOCKING DEVICE FOR THE RECIRCULATION LOOP IN A FUEL CELL STACK

(71) Applicant: Schaeffler Technologies AG & Co. KG, Herzongenaurach (DE)

(72) Inventors: Jan Pfannenmueller, Großhabersdorf (DE); Markus Popp, Frensdorf (DE)

(73) Assignee: Schaeffler Technologies AG & Co. KG, Herzogenaurach (DE)

(21) Appl. No.: 18/285,383

(22) PCT Filed: Feb. 7, 2022
(86) PCT No.: PCT/DE2022/100100

§ 371 Date: Oct. 2, 2023

(30) Foreign Application Priority Data
Apr. 7, 2021 (DE) 10 2021 108 577.2

(51) Int. Cl. H01M 8/04089; H01M 8/04223; H01M 8/0438

(52) U.S. Cl. CPC H01M 8/04097; H01M 8/04231; H01M 8/04388

(57) ABSTRACT

A blocking device for the recirculation loop in a fuel cell stack comprises a hydrogen inlet, a recirculation gas inlet, and a purge line. In order to dispense with the need for some valves, a recirculation loop blocking valve is provided which is switched by an upstream hydrogen switching valve, and a purge valve is integrated which is also configured as a pressure relief valve.

### CROSS-REFERENCE TO RELATED APPLICATIONS

This application is the U.S. National Phase of PCT Appln. No. PCT/DE2022/100100 filed Feb. 7, 2022, which claims priority to DE 102021108577.2 filed Apr. 7, 2021, the entire disclosures of which are incorporated by reference herein.

### TECHNICAL FIELD

The present disclosure relates to a blocking device for a recirculation loop in a fuel cell stack, comprising a hydrogen inlet, a recirculation gas inlet and a purge line.

### BACKGROUND

Fuel cells convert chemical energy of a fuel into electricity through a reaction with oxygen (usually from the air). The most commonly used fuel is hydrogen. Therefore, in the following, “hydrogen” will always be used to refer to the fuel, but this explicitly includes other gaseous fuels such as butane, propane, methane, methanol or other hydrocarbons.

Low-temperature fuel cells are known which have an ion-conducting polymer electrolyte separating an anode from a cathode. The hydrogen is fed to the anode compartment, the oxygen to the cathode compartment. The hydrogen ions travel through the electrolyte, while the electrons travel through an electrical circuit and a consumer outside of the cell. Such PEM fuel cells are also referred to as polymer electrolyte fuel cells (PEFCs), proton exchange membrane fuel cells (PEMFCs), or solid polymer fuel cells (SPFCs). Since a fuel cell normally generates a voltage of only approx. 1 V, several cells are usually connected to form so-called stacks in order to achieve a higher overall voltage.

During operation, hydrogen fuel cells are supplied with hydrogen superstoichiometrically, which means that they do not consume all the hydrogen in the anode compartment, as otherwise liquid water and inert gases would accumulate. In order not to waste the excess hydrogen, it is recycled, i.e., fed into a recirculation system. For this purpose, there exists the possibility of actively circulating the hydrogen with a mechanical pump or a blower. This is shown, for example, in WO 2012/104 191 A1 (or the parallel US 2013/0344406 A1). This device has a blocking device for the recirculation loop, a hydrogen inlet, a recirculation gas inlet and a purge or flushing line. This device forms the preamble of claim 1.

It is also possible to circulate the hydrogen passively by providing a jet pump with a nozzle for the fresh hydrogen, which carries the hydrogen to be recycled along with the higher fresh hydrogen pressure. Such a hydrogen supply with passive recirculation is shown in US 2020/0144 642 A1.

In some operating situations it is necessary or desirable to prevent the return of the recirculation loop. This is done via a blocking valve for the recirculation loop.

Furthermore, over the course of operation the recirculation gas accumulates nitrogen and other undesirable gases, which have to be vented from time to time depending on the operating strategy. This is done via a purge valve or discharge valve. When purging or discharging unwanted gases, it is advantageous if recirculation is prevented.

In addition, a pressure relief valve is required for safe operation. The valve opens automatically at a certain pressure and thus protects all components from damage or, in the most extreme case, from bursting.

Thus, three valves are necessary to enable safe operation. This is not an expense that can be considered negligible.

### SUMMARY

The present disclosure reduces the expense for valves for fuel cells with a recirculation loop.

According to an exemplary embodiment of the present disclosure, a blocking device for the recirculation loop in a fuel cell stack is provided with a hydrogen inlet, a recirculation gas inlet and a purge line, wherein a recirculation loop blocking valve is provided, which is switched by an upstream hydrogen switching valve, and a purge valve is integrated which is also designed as a pressure relief valve.

According to the present disclosure, three valve functions are thus combined in a single valve or component: A blocking valve for the recirculation loop, a purge valve and a pressure relief valve. This can save both the cost and effort associated with several valves and significantly simplifies the controlling effort, as only one actuator is required for all three functions. The blocking valve according to the present disclosure is suitable for fuel cells with both active and passive recirculation. The inventors have also recognized that there is a special relationship between purging and blocking the recirculation.

In embodiments, the upstream hydrogen switching valve is an inherently common controlled valve that opens or closes an opening. The recirculation loop blocking valve, on the other hand, is a slide valve whose valve piston can partially or completely close the somewhat larger line during its movement, and at the same time can mechanically actuate the purge valve. A single actuator is then sufficient to block and open the recirculation line and the purge line. The sliding piston can move transversely to the line to be opened and closed.

The purge valve can be actuated, i.e., opened, via a mechanical connection, for example a tappet. This tappet can be integrated directly into a valve slide of the recirculation loop blocking valve. If the recirculation loop blocking valve is closed, the mechanical connection opens the purge valve automatically via the direct coupling. One design variant of the tappet is that the purge valve is opened when the recirculation loop blocking valve is completely closed. The opening time changes due to different tappet lengths. A fixed tappet length means there is a fixed opening time. As shown in the figures below, purging can begin when the recirculation loop is 100% closed. It is also possible to use other design variants or tappet lengths, for example purging can begin when the recirculation loop is 50% closed or when it is 10% closed.

The hydrogen switching valve and the purge valve can be seat valves, which are therefore completely sealed. Since the purge valve can also assume the pressure relief valve function, it is recommended that it is designed as a spring-loaded non-return ball valve, wherein the spring is adjusted to the maximum permissible operating pressure.

According to the present disclosure, the recirculation loop blocking valve is controlled by high hydrogen pressure in a reservoir (currently up to 900 bar), wherein the hydrogen supply pressure then actuates the valve slide of the recirculation loop blocking valve. This can be the full reservoir pressure, but also another, lower pressure that is specified by the operator as desired. In some embodiments, a medium hydrogen pressure range is used, for example, up to 25 bar. The blocking valve, which—particularly in the case of passive recirculation—often has a significantly larger diameter, is not moved according to the present disclosure by its own electrical actuator, i.e., an auxiliary force, but is, as it were, triggered and opened by another force. Here the inventors use the energy that is already available in the stored fresh hydrogen or in a medium-pressure range as pressure energy and is available on site. After all, the relatively high pressure (force per area) of the hydrogen reservoir exerts a relatively high force when it strikes a piston (or its area) and thus also moves large pistons safely and reliably. In addition, the actual recirculation loop blocking valve also moves the purge valve, so that this does not require its own control either.

In order to use the hydrogen pressure, the hydrogen switching valve is connected upstream of the recirculation loop blocking valve and the purge valve in this case. The hydrogen switching valve can then be relatively small and can be moved by a small actuator. This upstream valve then switches the higher hydrogen pressure to the recirculation loop blocking valve. Since the hydrogen supply pressure is significantly greater than the pressure in the recirculation loop of the stack, the actual valve slide of the recirculation loop blocking valve moves to the “recirculation loop closed” valve position due to the pressure differences. The recirculation loop blocking valve then completely closes the recirculation loop, but it is still possible to supply the stack with fresh hydrogen at the same time and thus continue operation.

The stroke and cross-section of the three valves can be freely selected over a wide range. It is favorable if the valve stroke of the recirculation loop blocking valve is independent of the valve stroke or armature stroke of the hydrogen switching valve and the purge valve. Since this, as it were, only provides the impetus for the movement of the recirculation loop blocking valve, a small valve stroke is sufficient to allow the high hydrogen reservoir pressure to act on the recirculation loop blocking valve, which can then move it at a much larger stroke.

The switched cross-section of the recirculation loop blocking valve is also independent of the cross-section of the hydrogen switching valve. Even a small bore switching valve can allow the high hydrogen pressure to reach the large bore recirculation loop blocking valve and cause it to move. The cross-section or the bore of the recirculation loop blocking valve can be chosen freely and is dependent, for example, on the prevailing pressure conditions between the hydrogen supply pressure and the recirculation loop pressure in/on the stack.

The hydrogen switching valve can be controlled in a known manner, for example pneumatically, hydraulically or mechanically. As an example, the control can be electrical or electromagnetic, for example via a solenoid valve with an armature in a plunger coil.

It is possible that the piston of the valve moved by an actuator is actively pushed both in one direction and in the opposite direction, for example moved by the current flow in one direction and by the opposite current in the other direction. In embodiments, the hydrogen switching valve and/or the recirculation loop blocking valve and/or the purge valve each have a restoring mechanism, for example each have an integrated restoring spring. This restoring component then causes a movement in the opposite direction. The restoring element or springs can move the one, two or all three valves into the so-called fail-safe position. This means that, for example, the restoring spring of the hydrogen switching valve pushes it into the closed position, so that in the event of a power failure or another malfunction in the control system, the hydrogen switching valve is closed, leaving the downstream recirculation loop blocking valve open and thus keeping the normal recirculation loop open. This also means that, for example, the restoring spring of the recirculation loop blocking valve pushes it into the open position, so that in the event of a power failure or another malfunction in the control system, the recirculation loop blocking valve is open, i.e., the normal recirculation loop remains open. This is achieved via two springs. The fail-safe position of the purge and pressure relief valve is closed to maintain normal operation under slight overpressure.

In the embodiments with two valves connected in series, where one, here the hydrogen switching valve, is controlled and the other, here the recirculation loop blocking valve, is then pushed into the closed position by the high-pressure gas flow, it is advisable to provide a mechanism that allows the second valve to slide back to its initial position after a period of time. This can be a small bore that releases pressure after the first valve closes, allowing the second valve, the recirculation loop blocking valve, to return to its normal position after a certain period of time. In embodiments, the valve slide of the recirculation loop blocking valve has a certain amount of leakage, that is, its valve slide does not seal completely against the housing, so that the introduced gas escapes and the valve slide moves back automatically, for example via its restoring spring. Without this leakage, no pressure equalization would take place. This can be done by increased radial guide play and/or by a bore and/or by a relief groove.

If the fuel cell is intended to drive a vehicle, the hydrogen must be carried along with it and stored in a type of tank. For this purpose, it is stored either in liquid form or under pressure. Since extremely low temperatures (maximum of a few Kelvin) are required for liquid storage, storage under pressure (up to approx. 900 bar) has currently become established. This requires valves that are also designed for this high pressure range. Strong adjusting elements or actuators are often necessary here in order to carry out movements against these pressures. In embodiments of the present disclosure, a hydrogen switching valve is therefore used which has pressure compensation for the valve piston (or the armature in the case of solenoid valves) and thus significantly reduces the adjusting forces. This therefore means that lighter and weaker actuators can be used. In embodiments of the present disclosure, one or more overflow bores are therefore provided in the housing and/or in the actuator, which allow high-pressure hydrogen to reach the other side of the valve piston and thus only require a lower adjusting force. It is also possible to provide one or more longitudinal grooves in the piston or armature. Pressure compensation in the armature end stop is particularly useful.

In order to be able to reliably and completely fulfill the blocking function against the very high hydrogen pressure, provision can be made for the hydrogen switching valve and/or the purge valve to be assigned a sealing valve seat each. For example, a seat valve can be provided in the front stop of the actuator. The seat can be a ball seat or a flat valve face. Sealing elements can also be provided, such as one or more O-rings, overmolded seats or an overmolded valve slide.

The inventors have recognized that no recirculation should or needs to take place during purging. Therefore, both functions can be controlled simultaneously with the single valve proposed here, that is, when recirculation is stopped, purging can begin. Then, when the purging is finished, the recirculation can start again. Purging without recirculation has the advantage that gas with a high nitrogen content is discharged first. There is no mixing with fresh hydrogen, which increases the overall efficiency.

In embodiments, a stroke monitoring device is assigned to the purge valve. This monitoring device detects the triggering of the valve, for example by monitoring the valve stroke, a valve piston or when using a ball of the ball stroke. This results in a functional monitoring of the purging (when the switching valve is activated) and the monitoring of the pressure relief valve function (when the switching valve is switched off). Thanks to the integrated multifunctionality, the switching function of the recirculation blocking can also be checked in this way. A piston or ball stroke monitoring sensor system can be implemented, for example, by means of a Hall sensor, a reed contact or a contact resistance measurement. The opening of the purge valve can also be monitored indirectly, for example by measuring the pressure using a pressure sensor in the outlet or by monitoring the hydrogen in the outlet. A valve opening is then indicated by an increase in pressure or increased hydrogen content.

In embodiments, the recirculation loop blocking valve has pneumatic end position damping for one or both end positions of both stroke directions.

The blocking device according to the present disclosure can be made of any suitable material. The material must be able to withstand the mechanical loads and temperatures prevailing there. Thus, metal or plastic is recommended as the predominant material for the pistons, housing and lines. Elastic materials are recommended for the seals.

### BRIEF DESCRIPTION OF THE DRAWINGS

In the following, the present disclosure is explained by way of example with reference to the accompanying drawings using exemplary embodiments, wherein the features presented below can present an aspect of the present disclosure both individually and in combination. In the figures:

FIG. 1: shows a blocking device according to the present disclosure on a hydrogen injection device in a fuel cell stack and

FIGS. 2 to 5 show the blocking device of FIG. 1 in four different switching states.

### DETAILED DESCRIPTION

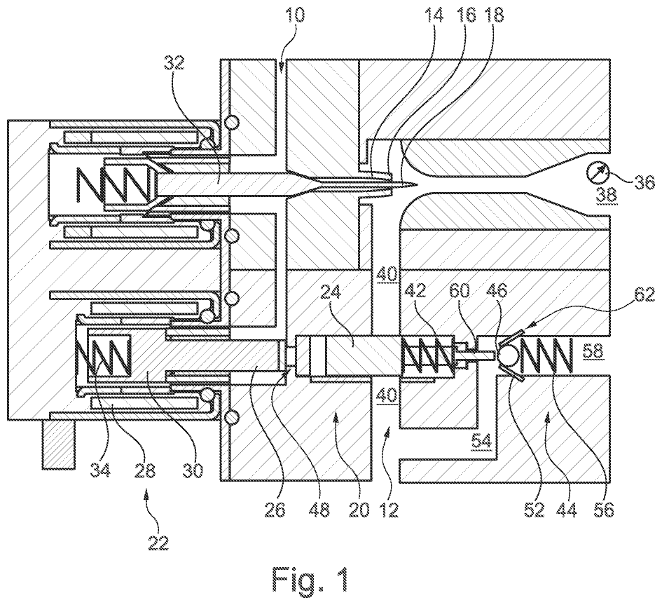

FIG. 1 shows a blocking device according to the present disclosure on a hydrogen injection device in a fuel cell stack with passive recirculation. The hydrogen injection device contains a hydrogen inlet 10, a recirculation gas inlet 12, and a jet pump 14 with a nozzle 16 and a nozzle needle 18. The jet pump 14 injects fresh hydrogen from the hydrogen inlet 10 via the nozzle 16. This hydrogen, which is under high pressure and is therefore fast, carries recirculation gas from the recirculation gas inlet 12 and the recirculation loop 40 in the direction of the gas outlet 38 to the anode compartment of the stack, as a result of which the passive recirculation is kept going. The gases mix in the suction chamber in front of the nozzle 16 and reach the gas outlet 38 through a mixing tube and a diffuser. The hydrogen control valve 32 is moved back and forth by a linear actuator with an electromagnet and thus controls the amount of fresh hydrogen supplied. A pressure sensor 36 measures the gas pressure in the anode compartment and thus provides a measure of the amount of hydrogen required.

Below the hydrogen injection device, but integrated here in the same housing, are the essential components of the blocking device according to the present disclosure for the recirculation loop 40, namely a hydrogen switching valve 22 with a valve piston or valve slide 26, a recirculation loop blocking valve 20 with a valve piston or valve slide 24, and a purge valve 44.

The hydrogen switching valve 22 is equipped with a linear actuator 28, for example an electromagnet, which can move the valve slide 26 back and forth via an armature 30. The valve slide 26 of the hydrogen switching valve 22 is pressed to the right by a restoring spring 34 into the right-hand stop and, with its valve seat 48, closes an opening there that leads from the hydrogen inlet 10 to the recirculation loop blocking valve 20 (normally closed position). In the hydrogen switching valve 22, next to the valve slide 26, there are two overflow bores which ensure pressure compensation.

To the right of said opening is the recirculation loop blocking valve 20, the valve slide 24 of which is pushed to the left by a restoring spring 42. In this left-hand stop position, the line from the recirculation loop 40 to the stack would be released, which leads to an open position for normal operation (normally open position). In FIG. 1, the valve slide 24 of the recirculation loop blocking valve 20 is not shown in one of its two end positions, but in an intermediate position in which the valve slide 24 of the recirculation loop blocking valve 20 closes the recirculation loop 40 between the recirculation gas inlet 12 and the stack. For the valve slide 24 of the recirculation loop blocking valve 20, two end position dampers are provided at the end stops, which can work pneumatically. Below the bore for the valve slide 24 of the recirculation loop blocking valve 20 are two longitudinal grooves, which allow gas to flow slowly past the valve slide 24 and serve as overflow bores. A tappet 60 is attached to the valve slide 24 and extends to the right in the direction of the purge valve 44.

The purge valve 44 is located on the far right. It has a valve ball 46 which is pressed by a spring 56 into a valve seat 52. The purge valve 44 is arranged in a purge line 54, which leads from the recirculation loop 40 to an outlet 58 to the outside. At the same time, it is located directly in the vicinity of the recirculation loop blocking valve 20 so that the tappet 60 can mechanically transmit the movement of the valve slide 24 to the ball 46. When the recirculation loop blocking valve 20 closes, the valve slide 24 moves to the right, closing the line of the recirculation loop 40 and, if it is far enough, transmits this movement to the ball 46 via its tappet 60. The tappet 60 thus lifts the ball 46 off its valve seat 52 and thereby opens the purge valve 44. Since in this embodiment the ball 46 of the purge valve 44 also has a surface which registers the pressure in the line 40 (and thus in the stack) via the line 54, the purge valve 44 also acts as a pressure relief valve. If the pressure in the stack, loop 40 or line 54 increases above a preset level, this pressure lifts the ball 46 from its valve seat 52 and allows the excess pressure to escape via the outlet 58 to the outside.

A stroke monitoring device 62 is located near the ball 46, which detects the position of the ball 46 and reports it to the control system.

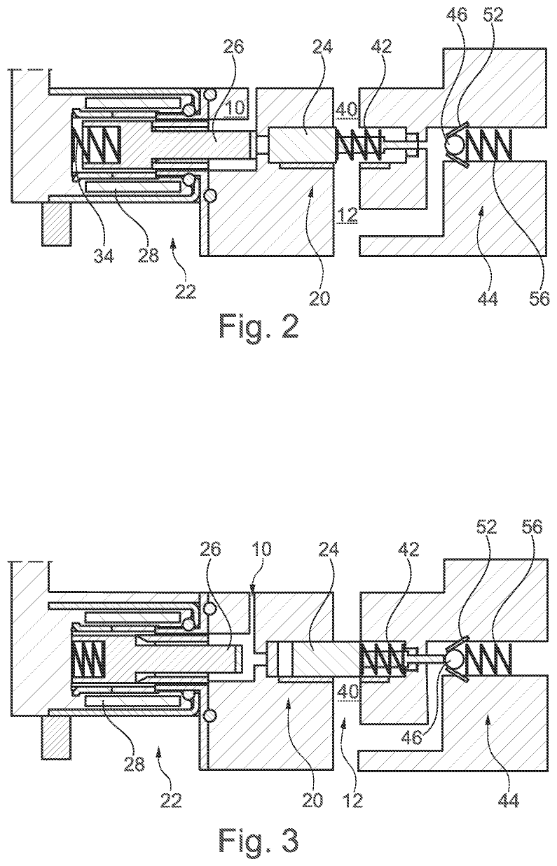

FIGS. 2 to 5 show the blocking device of FIG. 1 in four different switching states in order to explain the mode of operation.

FIG. 2 shows the fail-safe position of the three valves, the hydrogen switching valve 22, the recirculation loop blocking valve 20 and the purge valve 44, i.e., the rest position when everything is de-energized. Since the linear actuator 28 is not working, the restoring spring 34 presses the valve slide 26 of the hydrogen switching valve 22 into the right-hand end position, where the valve slide 26 closes the opening to the recirculation loop blocking valve 20. The hydrogen switching valve 22 is therefore closed. The high-pressure hydrogen gas cannot then reach the recirculation loop blocking valve 20 from the hydrogen inlet 10.

The second restoring spring 42 presses the valve slide 24 of the recirculation blocking valve 20 into the left-hand end position, so that the valve slide 24 leaves the recirculation loop 40 open. The recirculation loop blocking valve 20 is therefore open. The recirculation gas can thus reach upwards from the recirculation gas inlet 12 to the hydrogen injection device and thus to the stack.

The purge valve 44 is closed (fail-safe). The spring 56 presses the ball 46 against the valve seat 52.

FIG. 3 shows the three valves, the hydrogen switching valve 22, the recirculation loop blocking valve 20 and the purge valve 44, in a different position. The linear actuator 28 is now energized and pulls the valve slide 26 of the hydrogen switching valve 22 slightly to the left, so that the valve slide 26 opens the opening to the recirculation loop blocking valve 20. The hydrogen switching valve 22 is therefore open. The high-pressure hydrogen gas can thus reach the recirculation loop blocking valve 20 from the hydrogen inlet 10.

This high-pressure gas (or the hydrogen supply pressure) pushes the valve slide 24 of the recirculation blocking valve 20 to the right against the action of the spring 42, so that the valve slide 24 closes the recirculation loop 40. The recirculation loop blocking valve 20 is therefore closed. The recirculation gas can no longer reach upwards from the recirculation gas inlet 12 to the hydrogen injection device and thus to the stack.

The purge valve 44 is still closed. The spring 56 presses the ball 46 against the valve seat 52.

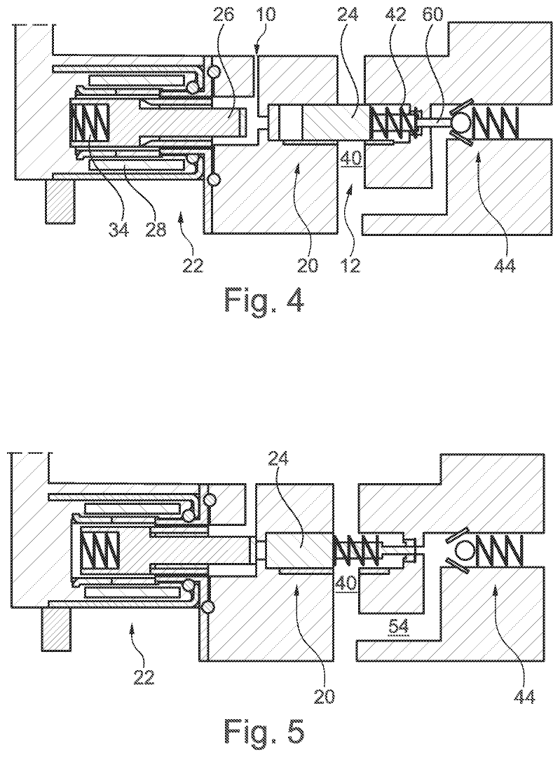

FIG. 4 shows the three valves, the hydrogen switching valve 22, the recirculation loop blocking valve 20 and the purge valve 44, in a further position. The linear actuator 28 is now further energized and pulls the valve slide 26 of the hydrogen switching valve 22 against the action of the spring 34 slightly to the left, so that the valve slide 26 leaves the opening to the recirculation loop blocking valve 20 open. The hydrogen switching valve 22 is therefore open. The high-pressure hydrogen gas can thus reach the recirculation loop blocking valve 20 from the hydrogen inlet 10.

This high-pressure gas (or the hydrogen supply pressure) pushes the valve slide 24 of the recirculation loop blocking valve 20 even further to the right against the action of the spring 42, so that the valve slide 24 keeps the recirculation loop 40 closed. The recirculation loop blocking valve 20 is therefore closed. The recirculation gas can no longer reach upwards from the recirculation gas inlet 12 to the hydrogen injection device and thus to the stack.

At the same time, the valve slide 24 is pressed far enough to the right that it opens the purge valve 44 via its tappet 60. The purge valve 44 is open. Since the hydrogen switching valve 22 is open, the pressure keeps the valve 44 open. The leakage caused by the grooves is compensated for by the supply of fresh hydrogen. The recirculation loop blocking valve 20 and the purge valve 44 are opened. If the hydrogen switching valve 22 is now closed, the pressure in front of the valve slide is reduced by an outflow via the grooves or the radial play. Depending on the dimensioning of the grooves or the radial play, the recirculation loop blocking valve 20 opens more quickly or more slowly. The purge valve 44 closes at the same time as the valve slide moves.

FIG. 5 shows how the purge valve 44 acts as a pressure relief valve 44.

As in FIG. 2, the hydrogen switching valve 22 is de-energized and closed.

Hydrogen supply pressure is not applied to the left of the valve slide 24 of the recirculation loop blocking valve 20. It is therefore open as in FIG. 2.

The excess pressure in the recirculation loop 40 reaches the purge valve 44 via the purge line 54, which now operates as a pressure relief valve 44, opens and discharges the excess pressure.

### LIST OF REFERENCE SYMBOLS

10 Hydrogen inlet
12 Recirculation gas inlet
14 Jet pump
16 Nozzle
18 Nozzle needle
20 Recirculation loop blocking valve
22 Hydrogen switching valve
24 Valve slide of the recirculation loop blocking valve
26 Valve slide of the hydrogen switching valve
28 Linear actuator
30 Armature
32 Hydrogen control valve
34 Restoring spring of the hydrogen switching valve
36 Pressure sensor
38 Gas outlet to the stack
40 Recirculation loop from the stack
42 Restoring spring of the recirculation loop blocking valve
44 Purge valve/pressure relief valve
46 Valve ball of the purge valve
48 Valve seat of the hydrogen switching valve
52 Valve seat of the purge valve
54 Purge line
56 Spring of the purge valve
58 Outlet
60 Tappet
62 Stroke monitoring device

1. A blocking device for a recirculation loop in a fuel cell stack comprising a hydrogen inlet, a recirculation gas inlet and a purge line, wherein a recirculation loop blocking valve is provided, which is switched by an upstream hydrogen switching valve, and a purge valve is integrated into the recirculation loop and is also configured as a pressure relief valve.

2. The blocking device according to claim 1, wherein the recirculation loop blocking valve is a slide valve which mechanically actuates the purge valve.

3. The blocking device according to claim 1, wherein the hydrogen switching valve is controlled electrically.

4. The blocking device according to claim 1, wherein at least one of the hydrogen switching valve, the recirculation loop blocking valve, and the purge valve has a restoring mechanism.

5. The blocking device according to claim 1, wherein the valve slide of the recirculation loop blocking valve is configured to permit a determined amount of leakage.

6. The blocking device according to claim 1, wherein the purge valve is actuated by means of a mechanical connection with the recirculation loop blocking valve.

7. The blocking device according to claim 1, wherein the hydrogen switching valve and the purge valve are seat valves.

8. The blocking device according to claim 1, wherein a stroke monitoring device is assigned to the purge valve.

9. The blocking device according to claim 1, wherein the recirculation loop blocking valve has pneumatic end position damping for at least one end position.

10. The blocking device according to claim 1, wherein the blocking device is substantially made of metal or plastic.

11. A blocking device for a recirculation loop in a fuel cell stack comprising:
an inlet;
a recirculation line in communication with the inlet;
a purge line in communication with the recirculation line;
a recirculation loop blocking valve arranged in the recirculation line and downstream of the purge line;
a switching valve arranged between the inlet and the recirculation loop blocking valve, the switching valve being configured to selectively permit communication from the inlet to the recirculation loop blocking valve; and
a purge valve arranged in the purge line, the recirculation loop blocking valve being engageable with the purge valve.

12. The blocking device according to claim 11, further comprising an actuator engaged with the switching valve, the actuator being configured to actuate the switching valve between an open position and a closed position.

13. The blocking device according to claim 11, wherein the switching valve is moveable between an open position and a closed position, wherein the switching valve prevents communication between the inlet and the recirculation loop blocking valve in the closed position and permits communication between the inlet and the recirculation loop blocking valve in the open position.

14. The blocking device according to claim 11, wherein the recirculation loop blocking valve is moveable between an open position and a closed position, wherein the recirculation loop blocking valve prevents communication through the recirculation line in the closed position and permits communication through the recirculation line in the open position.

15. The blocking device according to claim 11, wherein the purge valve is moveable between an open position and a closed position, wherein the purge valve prevents communication through purge line in the closed position and permits communication through the purge line in the open position.

16. The blocking device according to claim 15, wherein the purge valve includes a resilient element configured to bias the purge valve to the closed position.

17. The blocking device according to claim 15, wherein the recirculation loop blocking valve is moveable between an open position and a closed position, the recirculation blocking valve being configured to mechanically move the purge valve to the open position during movement of the recirculation blocking valve to the closed position.

18. The blocking device according to claim 17, wherein the recirculation loop blocking valve is configured to move to the closed position in response to a gas pressure from the inlet when the switching valve is in an open position.

19. The blocking device according to claim 17, wherein, in the open position, the recirculation loop blocking valve is spaced from the purge valve such that the purge valve is moveable in response to a gas pressure in the purge line.

20. The blocking device according to claim 17, wherein the recirculation loop blocking valve includes a resilient element configured to bias the purge valve to the open position.
